(19) United States
(12) Patent Application Publication
(10) Pub. No.: US 2023/0289687 A1
(43) Pub. Date: Sep. 14, 2023

(54) REPLACEMENT SUPPORT APPARATUS FOR SUPPORTING REPLACEMENT OF ELECTRONIC APPARATUS ACCORDING TO ACTUAL USAGE THEREOF

(71) Applicant: Panasonic Intellectual Property Management Co., Ltd., Osaka (JP)

(72) Inventors: Masashi SETO, Osaka (JP); Akira AMANO, Osaka (JP); Mitsuyoshi MATSUMOTO, Osaka (JP); Miyu MIYAJIMA, Osaka (JP); Masato TANAKA, Osaka (JP); Junya KAMIJIMA, Osaka (JP); Masakazu MATSUMOTO, Tokyo (JP); Kentaro TADA, Osaka (JP); Tomoyuki SHIMOMURA, Osaka (JP)

(21) Appl. No.: 18/111,029

(22) Filed: Feb. 17, 2023

(30) Foreign Application Priority Data
Mar. 9, 2022 (JP) 2022-036429

(51) Int. Cl. G06Q 10/0631

(52) U.S. Cl. CPC G06Q 10/06315

(57) ABSTRACT

A replacement support apparatus is provided for supporting replacement of a plurality of electronic apparatuses each including a plurality of device components. The replacement support apparatus is provided with: a communication circuit, a storage, a processing circuit, and an output device. The communication circuit receives, from a plurality of existing electronic apparatuses, operation information indicating operation conditions of the device components during operation of the existing electronic apparatuses. The storage stores specifications information indicating specifications of new electronic apparatuses as replacement candidates. The processing circuit statistically aggregates the operation information received from the plurality of existing electronic apparatuses, and selects a new electronic apparatus having specifications enabling operation conditions similar to operation conditions of a predetermined ratio of electronic apparatuses among the existing electronic apparatuses, based on the statistically aggregated operation information and the specifications information. The output device presents information on the selected new electronic apparatus.

### CROSS REFERENCE TO RELATED APPLICATION

This application claims benefit of priority to Japanese Patent Application 2022-036429, filed on Mar. 9, 2022, the entire content of which is incorporated herein by reference.

### BACKGROUND

### Technical Field

The present disclosure relates to a replacement support apparatus, a system, and a replacement support method for supporting replacement of an electronic apparatus, such as a personal computer.

### Background Art

When purchasing an electronic apparatus, such as a personal computer, it is convenient for a user to automatically present candidates suitable for the user’s requirements.

For example, Japanese Patent Laid-open Publication No. 2003-122965 (JP2003-122965) discloses a support system for replacing a personal computer in a case where an individual purchases a personal computer through a virtual shop as an online seller on the Internet. According to the system of JP2003-122965, a server obtains, from a user terminal to be replaced, hardware information on the user terminal, the hardware information being built in the user terminal, so that it is possible to easily find a personal computer having performance corresponding to desired usability of a purchaser.

### SUMMARY

However, in the system of JP2003-122965, the server apparatus obtains only simple hardware information (desktop management interface (DMI) information) of the user terminal, and it is difficult to propose candidates having specifications corresponding to the user’s actual usage. Therefore, it is required to propose candidates having specifications corresponding to the user’s actual usage.

An aspect of the present disclosure provides a replacement support apparatus, a system, and a replacement support method capable of presenting information on electronic apparatuses as replacement candidates having specifications corresponding to a user’s actual usage.

According to one aspect of the present disclosure, a replacement support apparatus is provided for supporting replacement of a plurality of electronic apparatuses each including a plurality of device components. The replacement support apparatus is provided with: a communication circuit, a storage, a processing circuit, and an output device. The communication circuit receives, from a plurality of existing electronic apparatuses, operation information indicating operation conditions of the device components during operation of the existing electronic apparatuses. The storage stores specifications information indicating specifications of new electronic apparatuses as replacement candidates. The processing circuit statistically aggregates the operation information received from the plurality of existing electronic apparatuses, and selects a new electronic apparatus having specifications enabling operation conditions similar to operation conditions of a predetermined ratio of electronic apparatuses among the existing electronic apparatuses, based on the statistically aggregated operation information and the specifications information. The output device presents information on the selected new electronic apparatus.

According to one aspect of the present disclosure, it is possible to present information on electronic apparatuses as replacement candidates having specifications corresponding to the user’s actual usage.

### BRIEF DESCRIPTION OF DRAWINGS

FIG. 1 is a schematic diagram illustrating a configuration of a system 100 according to an embodiment;

FIG. 2 is a block diagram illustrating a configuration of an electronic apparatus 1 of FIG. 1;

FIG. 3 is a block diagram illustrating a configuration of a server apparatus 2 of FIG. 1;

FIG. 4 is a block diagram illustrating a configuration of a terminal apparatus 3 of FIG. 1;

FIG. 5 is a schematic diagram illustrating hardware and software architecture of the electronic apparatus 1 of FIG. 1;

FIG. 6 is a flowchart illustrating a collection process for operation information, executed by a CPU 11 of the electronic apparatus 1 of FIG. 2;

FIG. 7 is a flowchart illustrating a determination process for USB port requirements, executed by a CPU 21 of the server apparatus 2 of FIG. 3;

FIG. 8 is a flowchart illustrating a determination process for battery requirements, executed by the CPU 21 of the server apparatus 2 of FIG. 3;

FIG. 9 is a flowchart illustrating a determination process for video output port requirements, executed by the CPU 21 of the server apparatus 2 in FIG. 3;

FIG. 10 is a flowchart illustrating a determination process for communication port requirements, executed by the CPU 21 of the server apparatus 2 of FIG. 3;

FIG. 11 is a flowchart illustrating a determination process for recommended model, executed by the CPU 21 of the server apparatus 2 in FIG. 3;

FIG. 12 is a graph illustrating in-use durations of USB ports 15b statistically aggregated in step S27 of FIG. 7;

FIG. 13 is a graph illustrating the number of simultaneously used USB ports 15b statistically aggregated in step S27 of FIG. 7;

FIG. 14 is a graph illustrating a discharge duration of a battery 16b statistically aggregated in step S40 of FIG. 8;

FIG. 15 is a graph illustrating in-use durations of the video output ports 14c statistically aggregated in step S67 of FIG. 9;

FIG. 16 is a graph illustrating the number of video output ports 14c statistically aggregated in step S67 of FIG. 9;

FIG. 17 is a graph illustrating in-use durations of communication ports statistically aggregated in step S84 of FIG. 10;

FIG. 18 is a table for explaining determination of robustness requirements of the electronic apparatus 1 in step S92 of FIG. 11;

FIG. 19 is a table illustrating exemplary recommended models presented in step S94 of FIG. 11;

FIG. 20 is a flowchart illustrating a collection process for operation information, executed by a CPU 11 of an electronic apparatus 1 according to a modified embodiment;

FIG. 21 is a flowchart illustrating a subroutine of step S101 (USB port monitoring process) of FIG. 20;

FIG. 22 is a flowchart illustrating a subroutine of step S102 (battery monitoring process) of FIG. 20;

FIG. 23 is a flowchart illustrating a subroutine of step S103 (video output port monitoring process) of FIG. 20; and

FIG. 24 is a flowchart illustrating a subroutine of step S104 (communication port monitoring process) of FIG. 20.

### DETAILED DESCRIPTION

Hereinafter, embodiments will be described in detail with reference to the drawings as appropriate. However, excessively detailed explanation may be omitted. For example, detailed explanation of well-known matters may be omitted, and redundant explanations on substantially the same configuration may be omitted. This is to avoid the unnecessary redundancy of the following description, and to facilitate understanding by those skilled in the art.

It is to be noted that the inventor(s) intends to provide the accompanying drawings and the following description so that those skilled in the art can sufficiently understand the present disclosure, and does not intend to limit subject matters recited in the claims.

### Configuration of Embodiment

FIG. 1 is a schematic diagram illustrating a configuration of a system 100 according to an embodiment. The system 100 of FIG. 1 is provided with: a plurality of electronic apparatuses 1-1 to 1-3, a server apparatus 2, a terminal apparatus 3, and a communication line 4.

The electronic apparatuses 1-1 to 1-3 are communicatively connected to the server apparatus 2 via the communication line 4. Each of the electronic apparatuses 1-1 to 1-3 is provided with a plurality of device components, such as USB ports, a battery, video output ports, and communication ports. The electronic apparatuses 1-1 to 1-3 are, for example, notebook, tablet, or desktop personal computers. The electronic apparatuses 1-1 to 1-3 belong to a certain group G1, such as a company, or a department of a company.

In the present specification, the electronic apparatuses 1-1 to 1-3 are also collectively referred to as “electronic apparatuses 1”.

The server apparatus 2 obtains, from the electronic apparatuses 1, operation information indicating operation conditions of the device components during operation of the electronic apparatuses 1, and selects models of new electronic apparatuses as replacement candidates of the electronic apparatuses 1, based on the operation information.

The terminal apparatus 3 is communicatively connected to the server apparatus 2 via the communication line 4 or other communication lines. The terminal apparatus 3 is used by, for example, an administrator of a company that owns the electronic apparatuses 1, or a sales representative of a company that sells the electronic apparatuses 1. Thus, the administrator or the sales representative can obtain information on new electronic apparatuses as replacement candidates of the electronic apparatuses 1, from the server apparatus 2. The administrator or the sales representative replaces the existing electronic apparatuses 1 with new electronic apparatuses. Here, the word “replacement” may indicate disposing the existing electronic apparatuses 1 and purchasing new electronic apparatuses, or may indicate moving electronic apparatuses without exchange of money.

The server apparatus 2 and the terminal apparatus 3 constitute an exemplary replacement support apparatus according to the embodiment.

The communication line 4 is, for example, a local area network (LAN), the Internet, a mobile phone network, or a combination thereof.

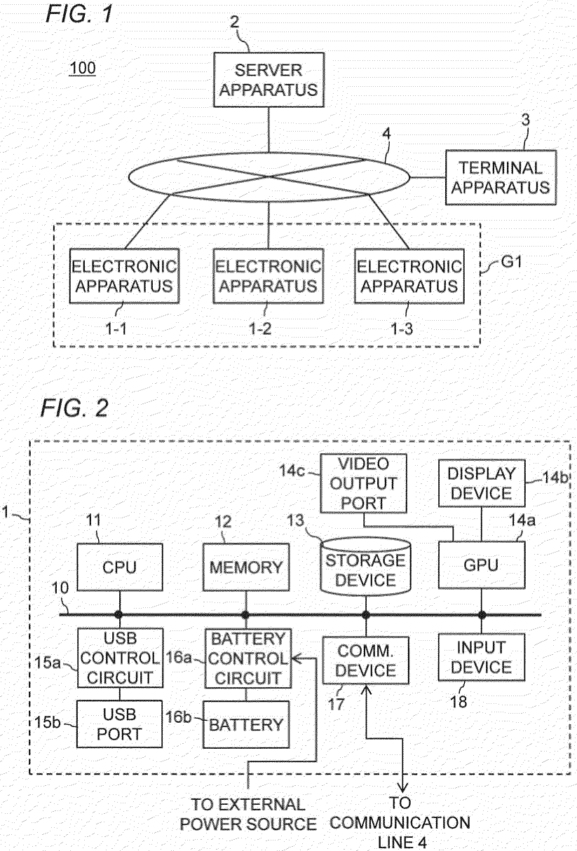

FIG. 2 is a block diagram illustrating a configuration of the electronic apparatus 1 of FIG. 1. The electronic apparatus 1 is provided with: a bus 10, a central processing unit (CPU) 11, a memory 12, a storage device 13, a graphics processing unit (GPU) 14a, a display device 14b, a video output port(s) 14c, a universal serial bus (USB) control circuit 15a, a USB port(s) 15b, a battery control circuit 16a, a battery 16b, a communication device 17, and an input device 18.

In the present specification, the components 11 to 18 of the electronic apparatus 1 are also referred to as “device components”.

The CPU 11 controls entire operation of the electronic apparatus 1, and for example, monitors operation conditions of the device components during operation of the electronic apparatus 1. CPU 11 is an example of a processing circuit or a signal processor in the present specification. The memory 12 temporarily stores programs and data necessary for the operation of the electronic apparatus 1. The storage device 13 stores data, including an operating system, application programs, and user data. The storage device 13 is a nonvolatile storage medium, such as a hard disk drive (HDD) or a solid state drive (SSD).

The GPU 14a further processes the data processed by the CPU 11, and outputs the processed data to the display device 14b. Additionally or alternatively, the GPU 14a may output the processed data to an external display device(s) connected via the video output port(s) 14c. The video output port(s) 14c includes, for example, one or more of terminals, such as a video graphics array (VGA) terminal, a high-definition multimedia interface (HDMI) (registered trademark) terminal, and a digital visual interface (DVI) terminal.

The USB control circuit 15a controls a peripheral device(es) connected via the USB port(s) 15b, in accordance with the USB 2.0 standard, the USB 3.1 standard, or the like. The USB port(s) 15b includes any one of a type A terminal, a type C terminal, and the like. The peripheral devices include, for example, a keyboard, a mouse, a storage device, a display device, a communication device, a printer, and the like.

The battery control circuit 16a is connected to an external power supply (not shown), and controls charging and discharging of the battery 16b. The electronic apparatus 1 operates with power supplied from an external power supply when connected to the external power supply, and operates with power discharged from the battery 16b when not connected to the external power supply.

The communication device 17 includes one or more communication ports, such as a wired local area network (LAN), a wireless LAN, and a wireless wide area network (WAN), and is communicatively connected to the server apparatus 2 via any of the communication ports and the communication line 4. The communication device 17 further includes one or more communication circuits which receives signals through the one or more communication ports, and/or transmits signals through the one or more communication ports.

The input device 18 receives a user input for controlling the operation of the electronic apparatus 1. The input device 18 includes, for example, a keyboard and a pointing device.

The CPU 11, the memory 12, the storage device 13, the GPU 14a, the USB control circuit 15a, the battery control circuit 16a, the communication device 17, and the input device 18 are connected to each other via the bus 10.

In the case where the electronic apparatus 1 is a desktop personal computer, the display device 14b and the input device 18 are provided outside the electronic apparatus 1, and connected to the electronic apparatus 1 via the video output port(s) 14c and the USB port(s) 15b, respectively.

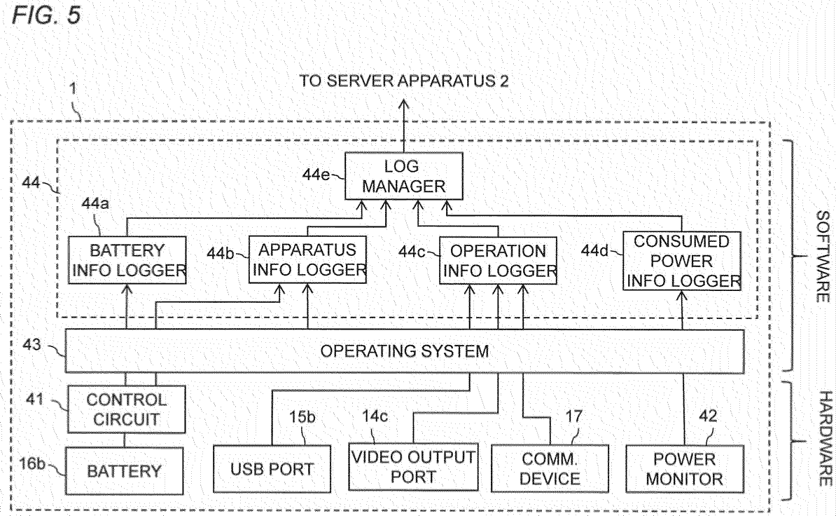

As will be described later with reference to FIG. 5, the electronic apparatus 1 may be further provided with a control circuit, such as an embedded controller, and may be further provided with a power monitor that monitors consumed power of the device components.

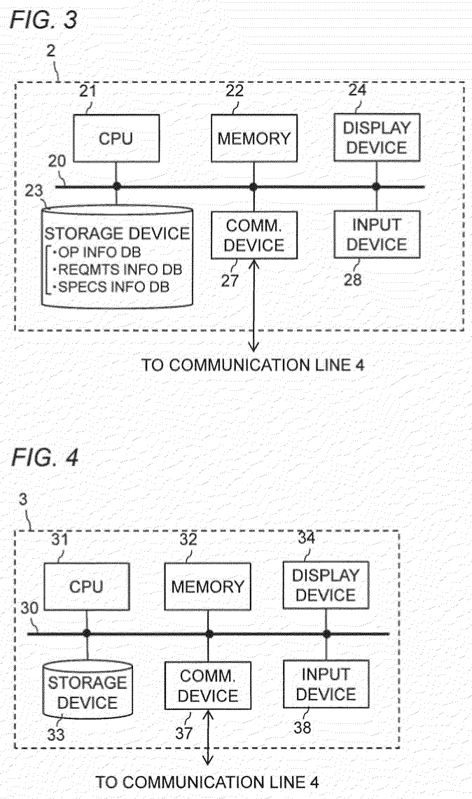

FIG. 3 is a block diagram illustrating a configuration of the server apparatus 2 of FIG. 1. The server apparatus 2 is provided with: a bus 20, a CPU 21, a memory 22, a storage device 23, a display device 24, a communication device 27, and an input device 28. The CPU 21 controls entire operation of the server apparatus 2, and selects models of new electronic apparatuses as replacement candidates of the electronic apparatuses 1. CPU 21 is an example of a processing circuit or a signal processor in the present specification. The memory 22 temporarily stores programs and data necessary for the operation of the server apparatus 2. The storage device 23 is a non-volatile storage medium that stores programs necessary for the operation of the server apparatus 2. The storage device 23 also stores an operation information database (OP INFO DB), a requirements information database (REQMTS INFO DB), and a specifications information database (SPECS INFO DB), each including data necessary for selecting models of new electronic apparatuses as replacement candidates of the electronic apparatuses 1. The operation information database includes operation information of device components of the electronic apparatuses 1, received from the electronic apparatuses 1. The requirements information database includes requirements information indicating specifications to be satisfied by new electronic apparatuses, based on data obtained by statistically aggregating operation information of the device components of the electronic apparatuses 1. Here, the phrase “statistically aggregating” means calculating the frequency or ratio at which a feature associated with a device component occurs among the electronic apparatuses 1. The specifications information database includes specifications information indicating specifications of new electronic apparatuses as replacement candidates. The display device 24 displays information related to the status of the server apparatus 2. The communication device 27 is communicatively connected to the electronic apparatus 1 and the terminal apparatus 3 via the communication line 4. The communication device 27 includes one or more communication circuits which receives signals through one or more communication ports, and/or transmits signals through the one or more communication ports. The input device 28 receives a user input for controlling the operation of the server apparatus 2. The input device 28 includes, for example, a keyboard and a pointing device. The CPU 21, the memory 22, the storage device 23, the display device 24, the communication device 27, and the input device 28 are connected to each other via the bus 20.

The server apparatus 2 may have business intelligence (BI) tool software for processing data to visualize the data in a form of a graph or the like.

FIG. 4 is a block diagram illustrating a configuration of the terminal apparatus 3 of FIG. 1. The terminal apparatus 3 is provided with: a bus 30, a CPU 31, a memory 32, a storage device 33, a display device 34, a communication device 37, and an input device 38. The CPU 31 controls entire operation of the terminal apparatus 3. The memory 32 temporarily stores programs and data necessary for the operation of the terminal apparatus 3. The storage device 33 is a non-volatile storage medium that stores programs necessary for the operation of the terminal apparatus 3. The display device 34 displays information related to the status of the terminal apparatus 3, and displays information on new electronic apparatuses as replacement candidates of the electronic apparatuses 1, the information being obtained from the server apparatus 2. The communication device 37 is communicatively connected to the server apparatus 2 via the communication line 4. The input device 38 receives a user input for controlling the operation of the terminal apparatus 3. The input device 38 includes, for example, a keyboard and a pointing device. The CPU 31, the memory 32, the storage device 33, the display device 34, the communication device 37, and the input device 38 are connected to each other via the bus 30.

The display device 34 of the terminal apparatus 3 is an exemplary output device that presents information on new electronic apparatuses selected by the server apparatus 2.

The server apparatus 2 provides an interface accessible to the terminal apparatus 3, such as a web-based interface, in order to present information on new electronic apparatuses as replacement candidates of the electronic apparatuses 1. In this case, the server apparatus 2 executes an application program for the web server, and the terminal apparatus 3 executes an application program for the web browser to access the web server on the server apparatus 2.

FIG. 5 is a schematic diagram illustrating hardware and software architecture of the electronic apparatus 1 of FIG. 1. In FIG. 5, only some of the device components of FIG. 2 are illustrated for ease of illustration.

In addition to the device components illustrated in FIG. 2, the electronic apparatus 1 may be provided with a control circuit 41, such as an embedded controller, and may be provided with a power monitor 42 that monitors consumed power of the device components. The CPU 11 executes an operating system 43 and application programs 44.

The application programs 44 include: a battery information logger 44a, an apparatus information logger 44b, an operation information logger 44c, a consumed power information logger 44d, and a log manager 44e. The battery information logger 44a obtains information, such as consumed power of the battery 16b, from the control circuit 41. The apparatus information logger 44b obtains, from the operating system 43, hardware information and various setting information of the electronic apparatus 1 itself. In addition, the apparatus information logger 44b obtains, from the control circuit 41, information less obtainable from the operating system 43, such as a model name, a product number, and a serial number of the electronic apparatus 1. The operation information logger 44c obtains, from the operating system 43, information on peripheral devices connected to the USB port(s) 15b, the video output port(s) 14c, and the communication port(s). The consumed power information logger 44d obtains, from the power monitor 42, information on the consumed power of each of the USB port(s) 15b, the video output port(s) 14c, and the communication port(s).

The consumed power information logger 44d may be, for example, an Energy Estimation Engine (E3) operating on Microsoft Windows (registered trademark).

The log manager 44e executes each of the battery information logger 44a, the apparatus information logger 44b, the operation information logger 44c, and the consumed power information logger 44d, and obtains information from each of the loggers 44a to 44d, in a periodical manner (for example, every few minutes or hours). The log manager 44e locally and temporarily stores the information obtained by the loggers 44a to 44d, and transmits the stored information to the server apparatus 2 in a periodical manner (for example, daily, weekly, or monthly).

The server apparatus 2 formats and stores logs of the operation information obtained from the electronic apparatuses 1.

### Operation of Embodiment

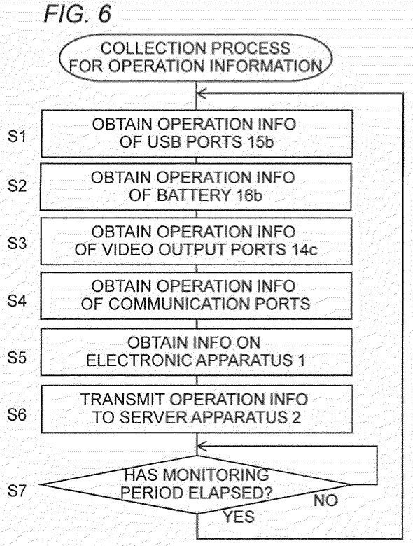

Next, an operation of the system according to the embodiment will be described with reference to FIGS. 6 to 19. The example of FIGS. 6 to 19 illustrates a case where each electronic apparatus 1 has: three USB ports 15b-1 to 15b-3; three video output ports 14c, that is, a VGA terminal, an HDMI terminal, and a DVI terminal; and three communication ports, that is, a wired LAN port, a wireless LAN port, and a wireless WAN port.

FIG. 6 is a flowchart illustrating a collection process for operation information, executed by the CPU 11 of the electronic apparatus 1 of FIG. 2.

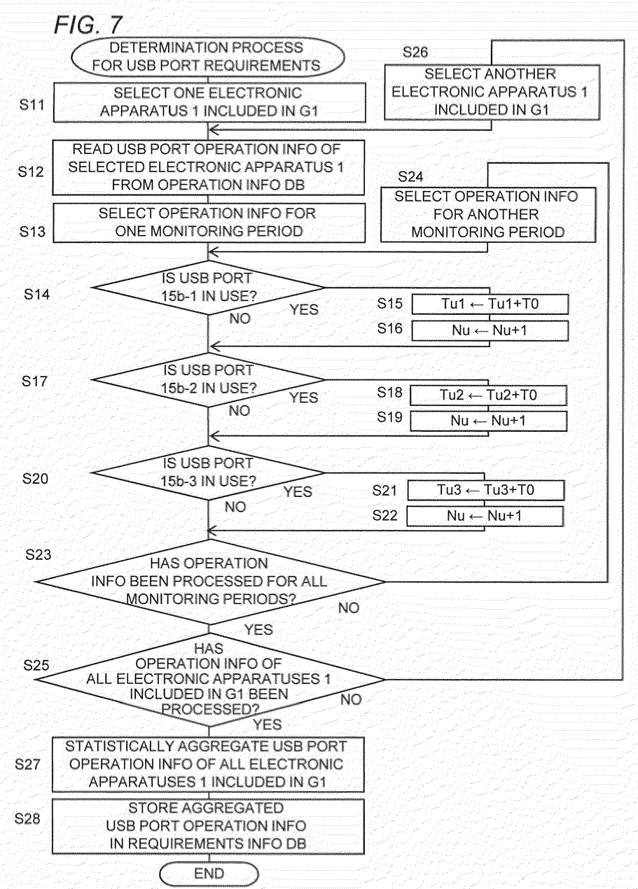

In step S1, the CPU 11 obtains operation information of the USB ports 15b. The operation information of the USB ports 15b includes, for example, at least one of: information indicating whether or not each USB port 15b is in use, an in-use duration of each USB port 15b, and the number of simultaneously used USB ports 15b. The phrase “USB port 15b is in use” means a status in which some peripheral device is connected to the USB port 15b. For example, the CPU 11 may obtain information indicating whether or not each USB port 15b is in use, from the operating system 43 or the control circuit 41. Further, as information indicating whether or not each USB port 15b is in use, the CPU 11 may obtain the value of the consumed power of the USB port 15b, from the power monitor 42. In this case, when the consumed power of the USB port 15b exceeds a predetermined minimum value, it is determined that the USB port 15b is in use. In the example of FIGS. 6 and 7, the electronic apparatus 1 obtains information indicating whether or not each USB port 15b is in use, and transmits this information to the server apparatus 2, and then, the server apparatus 2 calculates the in-use duration of each USB port 15b, and the number of simultaneously used USB ports 15b, based on this information.

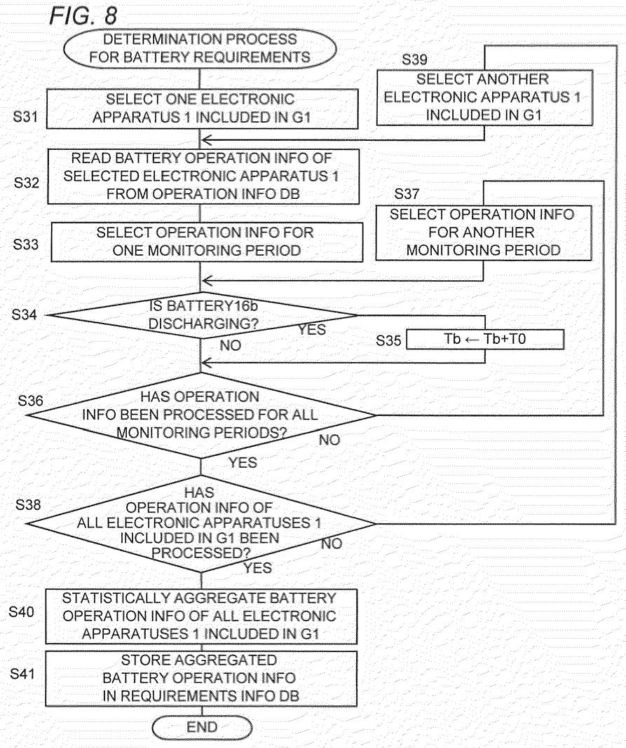

In step S2, the CPU 11 obtains operation information of the battery 16b. The operation information of the battery 16b includes, for example, information indicating whether or not the battery 16b is discharging, or a discharge duration of the battery 16b of the electronic apparatus 1. In the example of FIGS. 6 and 8, the electronic apparatus 1 obtains information indicating whether or not the battery 16b is discharging, and transmits this information to the server apparatus 2, and then, the server apparatus 2 calculates the discharge duration of the battery 16b of the electronic apparatus 1, based on this information.

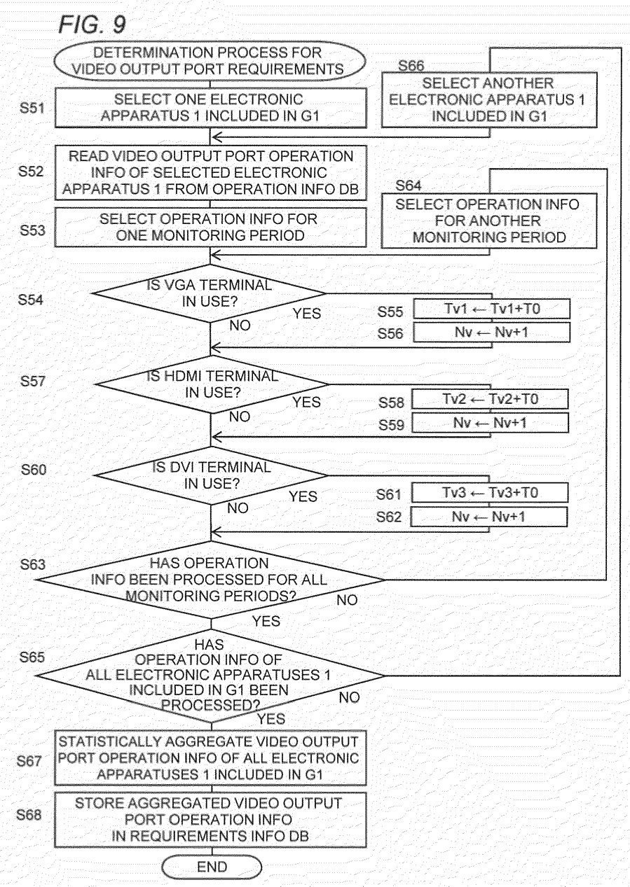

In step S3, the CPU 11 obtains the operation information of the video output ports 14c. The operation information of the video output ports 14c includes, for example, at least one of: information indicating whether or not each video output port 14c is in use, an in-use duration of each video output port 14c, and the number of simultaneously used video output ports 14c. The phrase “video output port 14c is in use” means a status in which an external display device is connected to the video output port 14c. For example, the CPU 11 may obtain information indicating whether or not each video output port 14c is in use, from the operating system 43 or the control circuit 41. Further, as the information indicating whether or not each video output port 14c is in use, the CPU 11 may obtain the value of the consumed power of the video output port 14c, from the power monitor 42. In this case, when the consumed power of the video output port 14c exceeds a predetermined minimum value, it is determined that the video output port 14c is in use. In the example of FIGS. 6 and 9, the electronic apparatus 1 obtains information indicating whether or not each video output port 14c is in use, and transmits this information to the server apparatus 2, and then, the server apparatus 2 calculates the in-use duration of each video output port 14c, and the number of simultaneously used video output ports 14c, based on this information.

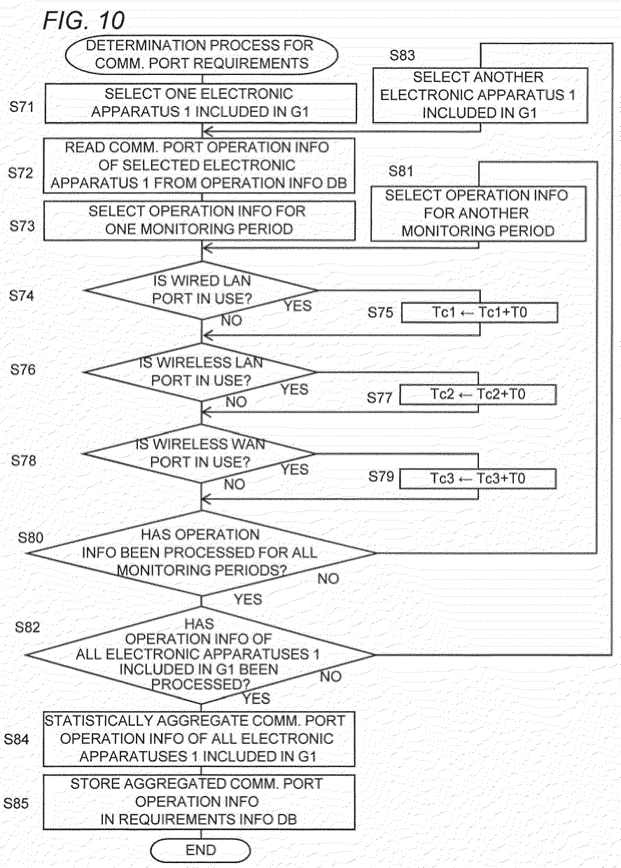

In step S4, the CPU 11 obtains operation information of the communication ports. The operation information of the communication ports includes, for example, at least one of: information indicating whether or not each communication port is in use, and an in-use duration of each communication port. The phrase “communication port is in use” means a status in which the electronic apparatus 1 is in communication with an external device via the communication port. For example, the CPU 11 may obtain information indicating whether or not each communication port is in use, from the operating system 43 or the control circuit 41. Further, as information indicating whether or not each communication port is in use, the CPU 11 may obtain the value of the consumed power of the communication port, from the power monitor 42. In this case, when the consumed power of the communication port exceeds a predetermined minimum value, it is determined that the communication port is in use. In the example of FIGS. 6 and 10, the electronic apparatus 1 obtains information indicating whether or not each communication port is in use, and transmits this information to the server apparatus 2, and then, the server apparatus 2 calculates the in-use duration of each communication port, based on this information.

In step S5, the CPU 11 obtains information on the electronic apparatus 1 itself. The information on the electronic apparatus 1 itself includes, for example, a model name, a product number, and a serial number of the electronic apparatus 1.

In step S6, the CPU 11 transmits the respective operation information obtained in steps S1 to S4, and the information on the electronic apparatus 1 itself obtained in step S5, to the server apparatus 2.

In step S7, the CPU 11 determines whether or not a monitoring period has elapsed: if YES, the process returns to step S1; and if NO, the process repeats step S7.

By executing the collection process for operation information of FIG. 6, the electronic apparatus 1 periodically obtains the operation information of the USB port(s) 15b, the battery 16b, the video output port(s) 14c, and the communication port(s) for each monitoring period of a time length T0, and transmits the operation information to the server apparatus 2. The operation information indicates operation conditions of the USB port(s) 15b, the battery 16b, the video output port(s) 14c, and the communication port(s) at a certain moment in the monitoring period. Thus, the operation information includes time series data of the operation conditions.

The server apparatus 2 stores the operation information and the information on the electronic apparatus 1 itself, which are received from each electronic apparatus 1, in the operation information database of the storage device 23. Every time the operation information over the predetermined number of monitoring periods has been obtained, the server apparatus 2 executes the processes of FIGS. 7 to 10 to determine the requirements information of the USB port(s) 15b, the battery 16b, the video output port(s) 14c, and the communication port(s). In this case, in order to determine the requirements information, the server apparatus 2 statistically aggregates the operation information received from the plurality of electronic apparatuses 1 included in the group G1.

FIG. 7 is a flowchart illustrating a determination process for USB port requirements, executed by the CPU 21 of the server apparatus 2 of FIG. 3.

In step S11, the CPU 21 selects one electronic apparatus 1 included in the group G1.

In step S12, the CPU 21 reads the USB port operation information of the selected electronic apparatus 1 over a predetermined number of monitoring periods, from the operation information database of the storage device 23. Further, the CPU 21 initializes parameters Tu1 to Tu3 and Nu to 0, where Tu1 to Tu3indicate the in-use durations of the USB ports 15b-1 to 15b-3 of the selected electronic apparatus 1, respectively, and Nu indicates the number of simultaneously used USB ports.

The USB port operation information read from the operation information database includes, for example, the following items.
Date and time
Model name or product number of electronic apparatus
Time series data of consumed power of USB port 15b-1
Time series data of consumed power of USB port 15b-2
Time series data of consumed power of USB port 15b-3

In step S13, the CPU 21 selects USB port operation information for one monitoring period.

In step S14, the CPU 21 determines whether or not the USB port 15b-1 is in use: if YES, the process proceeds to step S15; if NO the process proceeds to step S17. In step S15, the CPU 21 increments the in-use duration Tu1 of the USB port 15b-1 by the time length T0 of the monitoring period. In step S16, the CPU 21 increments the number Nu of simultaneously used USB ports by 1 among the USB ports 15b-1 to 15b-3 of the selected electronic apparatus 1.

In step S17, the CPU 21 determines whether or not the USB port 15b-2 is in use: if YES, the process proceeds to step S18; if NO the process proceeds to step S20. In step S18, the CPU 21 increments the in-use duration Tu2 of the USB port 15b-2 by the time length T0 of the monitoring period. In step S19, the CPU 21 increments the number Nu of simultaneously used USB ports by 1.

In step S20, the CPU 21 determines whether or not the USB port 15b-3 is in use: if YES, the process proceeds to step S21; if NO the process proceeds to step S23. In step S21, the CPU 21 increments the in-use duration Tu3 of the USB port 15b-3 by the time length T0 of the monitoring period. In step S22, the CPU 21 increments the number Nu of simultaneously used USB ports by 1.

In step S23, the CPU 21 determines whether or not the USB port operation information of the selected electronic apparatus 1 has been processed over all the monitoring periods: if YES, the process proceeds to step S25; if NO the process proceeds to step S24. In step S24, the CPU 21 selects USB port operation information for another monitoring period, and then, repeats steps S14 to S23.

By executing steps S13 to S24, the CPU 21 determines the in-use durations Tu1 to Tu3 of the USB ports 15b-1 to 15b-3 of the selected electronic apparatus 1, and the maximum value of the number Nu of simultaneously used USB ports.

In step S25, the CPU 21 determines whether or not the USB port operation information of all the electronic apparatuses 1 included in the group G1 has been processed: if YES, the process proceeds to step S27; if NO the process proceeds to step S26. In step S26, the CPU 21 selects another electronic apparatus 1 included in the group G1, and then, repeats steps S12 to S25.

In step S27, the CPU 21 statistically aggregates the USB port operation information of all the electronic apparatuses 1 included in the group G1. In this case, the CPU 21 may calculate, for example, the frequency of the in-use duration for each of the USB ports 15b-1 to 15b-3, as the USB port operation information statistically aggregated over the plurality of electronic apparatuses 1. In addition, the CPU 21 may calculate proportions of different numbers of simultaneously used USB ports 15b, as the USB port operation information statistically aggregated over the plurality of electronic apparatuses 1. In step S28, the CPU 21 stores the statistically aggregated USB port operation information, as USB port requirements, in the requirements information database of the storage device 23.

The USB port requirements stored in the requirements information database include, for example, the following items.
Period
Model name or product number of electronic apparatus
in-use duration of USB port 15b-1
in-use duration of USB port 15b-2
in-use duration of USB port 15b-3
Number of USB ports that can be used simultaneously

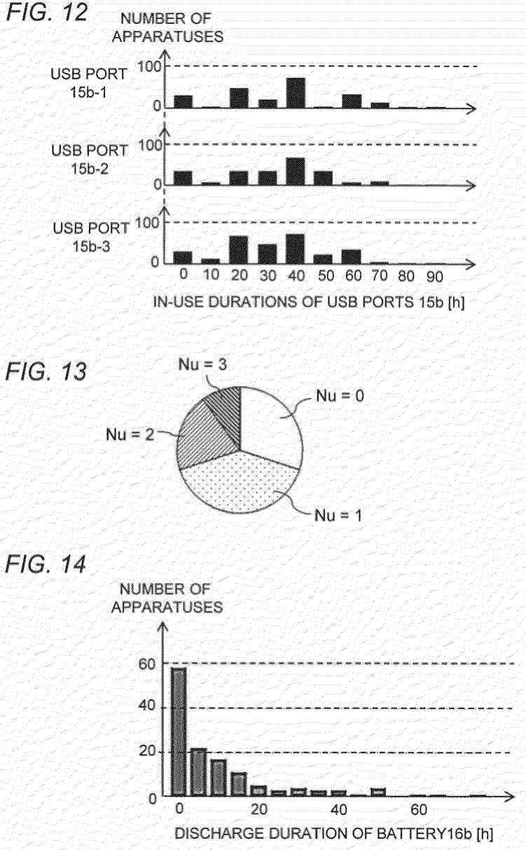

FIG. 12 is a graph illustrating in-use durations of USB ports 15b statistically aggregated in step S27 of FIG. 7. FIG. 13 is a graph illustrating the number of simultaneously used USB ports 15b statistically aggregated in step S27 of FIG. 7. As illustrated in FIGS. 12 and 13, by statistically aggregating the USB port operation information of the plurality of electronic apparatuses 1, it is possible to understand a trend of a demand of the USB ports 15b as to how many USB ports 15b should be provided to electronic apparatuses as replacement candidates

FIG. 8 is a flowchart illustrating a determination process for battery requirements, executed by the CPU 21 of the server apparatus 2 of FIG. 3.

In step S31, the CPU 21 selects one electronic apparatus 1 included in the group G1.

In step S32, the CPU 21 reads the battery operation information of the selected electronic apparatus 1 over a predetermined number of monitoring periods, from the operation information database of the storage device 23. Further, the CPU 21 initializes a parameter Tb to 0, where Tb indicates a discharge duration of the battery 16b of the selected electronic apparatus 1.

The battery operation information read from the operation information database includes, for example, the following items.
Date and time
Model name or product number of electronic apparatus
Time series data of flag indicating charging/or discharging

In step S33, the CPU 21 selects battery operation information for one monitoring period.

In step S34, the CPU 21 determines whether or not the battery 16b is discharging: if YES, the process proceeds to step S35; if NO the process proceeds to step S36. In step S35, the CPU 21 increments the discharge duration Tb of the battery 16b by the time length T0 of the monitoring period.

In step S36, the CPU 21 determines whether or not the battery operation information of the selected electronic apparatus 1 has been processed over all the monitoring periods: if YES, the process proceeds to step S38; if NO the process proceeds to step S37. In step S37, the CPU 21 selects USB port operation information for another monitoring period, and then, repeats steps S34 to S36.

By executing steps S33 to S37, the CPU 21 determines the discharge duration Tb of the battery 16b of the selected electronic apparatus 1.

In step S38, the CPU 21 determines whether or not the battery operation information of all the electronic apparatuses 1 included in the group G1 has been processed: if YES, the process proceeds to step S40; if NO the process proceeds to step S39. In step S39, the CPU 21 selects another electronic apparatus 1 included in the group G1, and then, repeats steps S32 to S38.

In step S40, the CPU 21 statistically aggregates the battery operation information of all the electronic apparatuses 1 included in the group G1. In this case, the CPU 21 may calculate, for example, the frequency of the discharge duration of the battery 16b, as the battery operation information statistically aggregated over the plurality of electronic apparatuses 1. In step S41, the CPU 21 stores the statistically aggregated battery operation information, as battery requirements, in the requirements information database of the storage device 23.

The battery requirements stored in the requirements information database include, for example, the following items.
Period
Model name or product number of electronic apparatus
discharge duration

FIG. 14 is a graph illustrating a discharge duration of the battery 16b statistically aggregated in step S40 of FIG. 8. As illustrated in FIG. 14, by statistically aggregating the battery operation information of the plurality of electronic apparatuses 1, it is possible to understand a trend of the capacity of a battery to be provided to electronic apparatuses as replacement candidates.

FIG. 9 is a flowchart illustrating a determination process for video output port requirements, executed by the CPU 21 of the server apparatus 2 in FIG. 3.

In step S51, the CPU 21 selects one electronic apparatus 1 included in the group G1.

In step S52, the CPU 21 reads the video output port operation information of the selected electronic apparatus 1 over a predetermined number of monitoring periods, from the operation information database of the storage device 23. Further, the CPU 21 initializes parameters Tv1 to Tv3 and Nv to 0, where Tv1 to Tv3 indicate the in-use durations of the video output ports 14c of the selected electronic apparatus 1, that is, the VGA terminal, the HDMI terminal, and the DVI terminal, and Nv indicates the number of simultaneously used video output ports.

The video output port operation information read from the operation information database includes, for example, the following items.

Date and time
Model name or product number of electronic apparatus
Time series data of consumed power of VGA terminal
Time series data of consumed power of HDMI terminal
Time series data of consumed power of DVI terminal

In step S53, the CPU 21 selects video output port operation information for one monitoring period.

In step S54, the CPU 21 determines whether or not the VGA terminal is in use: if YES, the process proceeds to step S55; if NO the process proceeds to step S57. In step S55, the CPU 21 increments the in-use duration Tv1 of the VGA terminal by the time length T0 of the monitoring period. In step S56, the CPU 21 increments the number Nv of simultaneously used video output ports among the video output ports 14c of the selected electronic apparatus 1 by 1.

In step S57, the CPU 21 determines whether or not the HDMI terminal is in use: if YES, the process proceeds to step S58; if NO the process proceeds to step S60. In step S58, the CPU 21 increments the in-use duration Tv2 of the HDMI terminal by the time length T0 of the monitoring period. In step S59, the CPU 21 increments the number Nv of simultaneously used video output ports by 1.

In step S60, the CPU 21 determines whether or not the DVI terminal is in use: if YES, the process proceeds to step S61; if NO the process proceeds to step S63. In step S61, the CPU 21 increments the in-use duration Tv3 of the DVI terminal by the time length T0 of the monitoring period. In step S62, the CPU 21 increments the number Nv of simultaneously used video output ports by 1.

In step S63, the CPU 21 determines whether or not the video output port operation information of the selected electronic apparatus 1 has been processed over all the monitoring periods: if YES, the process proceeds to step S65; if NO the process proceeds to step S64. In step S64, the CPU 21 selects video output port operation information for another monitoring period, and then, repeats steps S54 to S63.

By executing steps S53 to S64, the CPU 21 determines the in-use durations Tu1 to Tu3 of the video output ports 14c of the selected electronic apparatus 1, and the maximum value of the number Nu of simultaneously used video output ports 14c.

In step S65, the CPU 21 determines whether or not the video output port operation information of all the electronic apparatuses 1 included in the group G1 has been processed: if YES, the process proceeds to step S67; if NO the process proceeds to step S66. In step S66, the CPU 21 selects another electronic apparatus 1 included in the group G1, and then, repeats steps S52 to S65.

In step S67, the CPU 21 statistically aggregates the video output port operation information of all the electronic apparatuses 1 included in the group G1. In this case, the CPU 21 may calculate, for example, the frequency of the in-use duration for each of the VGA terminal, the HDMI terminal, and the DVI terminal, as the video output port operation information statistically aggregated over the plurality of electronic apparatuses 1. In addition, the CPU 21 may calculate proportions of different numbers of simultaneously used video output ports 14c, as the video output port operation information statistically aggregated over the plurality of electronic apparatuses 1. In step S68, the CPU 21 stores the statistically aggregated video output port operation information, as video output port requirements, in the requirements information database of the storage device 23.

The video output port requirements stored in the requirements information database include, for example, the following items.
Period
Model name or product number of electronic apparatus
in-use duration of VGA terminal
in-use duration of HDMI terminal
in-use duration of DVI terminal
Number of video output ports that can be used simultaneously

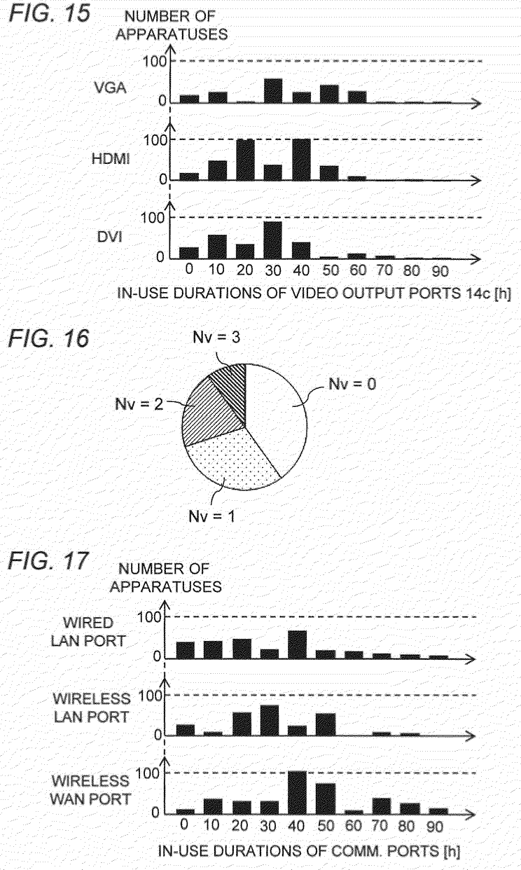

FIG. 15 is a graph illustrating in-use durations of the video output ports 14c statistically aggregated in step S67 of FIG. 9. FIG. 16 is a graph illustrating the number of video output ports 14c statistically aggregated in step S67 of FIG. 9. As illustrated in FIGS. 15 and 16, by statistically aggregating the video output port operation information of the plurality of electronic apparatuses 1, it is possible to understand a trend of a demand of the video output port 14c as to what type of video output port 14c should be provided, and how many video output ports 14c should be provided to electronic apparatuses as replacement candidates.

FIG. 10 is a flowchart illustrating a determination process for communication port requirements, executed by the CPU 21 of the server apparatus 2 of FIG. 3.

In step S71, the CPU 21 selects one electronic apparatus 1 included in the group G1.

In step S72, the CPU 21 reads the communication port operation information of the selected electronic apparatus 1 over a predetermined number of monitoring periods, from the operation information database of the storage device 23. Further, the CPU 21 initializes parameters Tc1 to Tc3 and Nc, where Tc1 to Tc3 indicate the in-use durations of the communication ports of the selected electronic apparatus 1, that is, the wired LAN port, the wireless LAN port, and the wireless WAN port, respectively, and Nc indicates the number of simultaneously used communication ports to 0.

The communication port operation information read from the operation information database includes, for example, the following items.
Date and time
Model name or product number of electronic apparatus
Time series data of consumed power of wired LAN port
Time series data of consumed power of wireless LAN port
Time series data of consumed power of wireless WAN Port

In step S73, the CPU 21 selects communication port operation information for one monitoring period.

In step S74, the CPU 21 determines whether or not the wired LAN port is in use: if YES, the process proceeds to step S75; if NO the process proceeds to step S76. In step S75, the CPU 21 increments the in-use duration Tc1 of the wired LAN port by the time length T0 of the monitoring period.

In step S76, the CPU 21 determines whether or not the wireless LAN port is in use: if YES, the process proceeds to step S77; if NO the process proceeds to step S78. In step S77, the CPU 21 increments the in-use duration Tc2 of the wireless LAN port by the time length T0 of the monitoring period.

In step S78, the CPU 21 determines whether or not the wireless WAN port is in use: if YES, the process proceeds to step S79; if NO the process proceeds to step S80. In step S79, the CPU 21 increments the in-use duration Tc3 of the wireless WAN port by the time length T0 of the monitoring period.

In step S80, the CPU 21 determines whether or not the communication port operation information of the selected electronic apparatus 1 has been processed over all the monitoring periods: if YES, the process proceeds to step S82; if NO the process proceeds to step S81. In step S81, the CPU 21 selects communication port operation information for another monitoring period, and then, repeats steps S74 to S80.

By executing steps S73 to S80, the CPU 21 determines the in-use durations Tc1 to Tc3 of the communication ports of the selected electronic apparatus 1.

In step S82, the CPU 21 determines whether or not the communication port operation information of all the electronic apparatuses 1 included in the group G1 has been processed: if YES, the process proceeds to step S84; if NO the process proceeds to step S83. In step S83, the CPU 21 selects another electronic apparatus 1 included in the group G1, and then, repeats steps S72 to S82.

In step S84, the CPU 21 statistically aggregates the communication port operation information of all the electronic apparatuses 1 included in the group G1. In this case, the CPU 21 may calculate, for example, the frequency of the in-use duration for each of the wired LAN port, the wireless LAN port, and the wireless WAN port, as the communication port operation information statistically aggregated over the plurality of electronic apparatuses 1. In step S85, the CPU 21 stores the statistically aggregated communication port operation information, as communication port requirements, in the requirements information database of the storage device 23.

The communication port requirements stored in the requirements information database include, for example, the following items.
Period
Model name or product number of electronic apparatus
in-use duration of wired LAN port
in-use duration of wireless LAN port
in-use duration of wireless WAN port

FIG. 17 is a graph illustrating in-use durations of communication ports statistically aggregated in step S84 of FIG. 10. As illustrated in FIG. 17, by statistically aggregating the communication port operation information of the plurality of electronic apparatuses 1, it is possible to understand a trend of a demand of the communication ports as to what type of communication port should be provided to electronic apparatuses as replacement candidates.

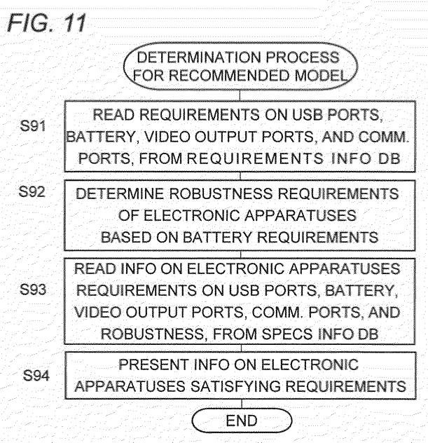

FIG. 11 is a flowchart illustrating a determination process for recommended model, executed by the CPU 21 of the server apparatus 2 in FIG. 3.

In step S91, the CPU 21 reads the USB port requirement, the battery requirement, the video output port requirement, and the communication port requirements from the requirements information database of the storage device 23.

In step S92, the CPU 21 determines robustness requirements of the electronic apparatus based on the battery requirement. While the battery 16 is discharging, there is a high possibility that the electronic apparatus is being moved. It is considered that as the discharge duration of the battery 16 increases, a risk that the electronic apparatus receives an impact due to falling during movement or the like increases. Therefore, the CPU 21 determines the robustness requirements of the electronic apparatus so that the longer the discharge duration of the battery 16b, the higher the robustness.

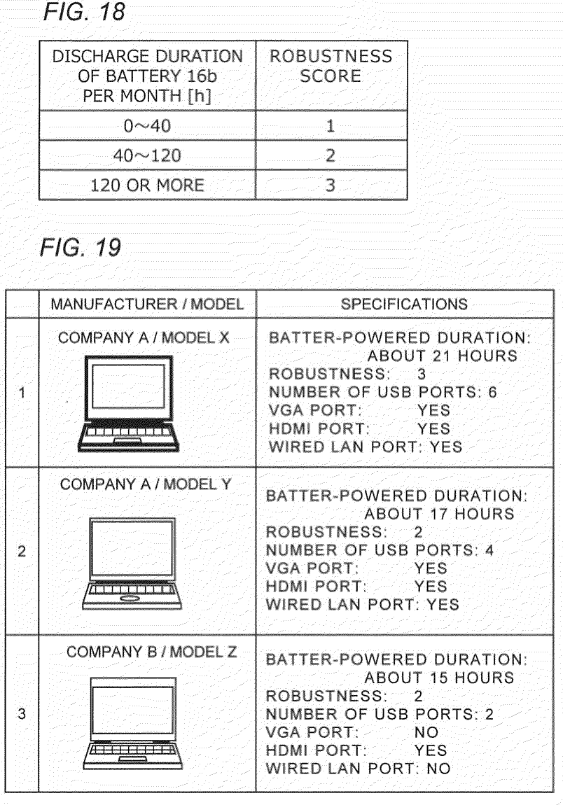

FIG. 18 is a table for explaining determination of the robustness requirements of the electronic apparatus 1 in step S92 of FIG. 11. The CPU 21 increases the robustness score as the discharge duration of the battery 16b increases. The robustness score indicates that the electronic apparatus has passed a predetermined shock or vibration test, such as MIL-STD-810G or MIL-STD-810H, or that the electronic apparatus is provided with predetermined reinforcing members. In the example of FIG. 18, the higher the robustness score, the more robust the electronic apparatus.

In step S93, the CPU 21 reads models of electronic apparatuses satisfying the USB port requirement, the battery requirement, the video output port requirement, the communication port requirement, and the robustness requirements, from the specifications information database of the storage device 23.

The specifications information includes, for example, the following items.
Manufacturer
Model name or product number of electronic apparatus
Thumbnail Image
Number of USB type A ports
Number of USB type C ports
With/without HDMI terminal
With/without DVI terminal
With/without wired LAN port
Robustness score

The CPU 21 may select new electronic apparatuses having specifications enabling operation conditions similar to the operation conditions of all the electronic apparatuses in the group G1, based on the requirements information and the specifications information. Further, the CPU 21 may select new electronic apparatuses having specifications enabling operation conditions similar to the operation conditions of a predetermined ratio of electronic apparatuses, for example, 50% to 90%, among the electronic apparatuses of the group G1, based on the requirements information and the specifications information.

In step S94, in response to a request from the terminal apparatus 3, the CPU 21 transmits information on the electronic apparatuses satisfying the requirements, to the terminal apparatus 3. The CPU 31 of the terminal apparatus 3 outputs the information on the electronic apparatus received from the server apparatus 2, to the display device 34. As a result, it is possible to present information on the electronic apparatuses satisfying the requirements, as replacement candidates of electronic apparatuses 1 included in the group G1, to an administrator a sales representative.

FIG. 19 is a table illustrating exemplary recommended models presented in step S94 of FIG. 11. FIG. 19 illustrates a case where there are three models of electronic apparatuses satisfying the requirements. When there are multiple models of electronic apparatuses satisfying the requirements, the electronic apparatuses may be ordered according to some score value. The score values may be weighted to prioritize some function of the electronic apparatus.

The user of the electronic apparatus 1 can refer to the electronic apparatuses displayed on the terminal apparatus 3 to purchase a desired electronic apparatus.

The CPU 21 of the server apparatus 2 may transmit the statistically aggregated operation information, as well as the information on the electronic apparatuses satisfying the requirements, to the terminal apparatus 3. In this case, the CPU 31 of the terminal apparatus 3 outputs the graphs of FIGS. 12 to 17 to the display device 34. As a result, the user of the electronic apparatus 1 can refer to the statistically aggregated operation information to purchase an optimal electronic apparatus in accordance with actual usage of the device components of the electronic apparatus 1.

As described above, according to the system of the embodiment, by obtaining the operation information indicating the operation conditions of the device components during the operation of the existing electronic apparatuses, it is possible to present information on electronic apparatuses as replacement candidates having specifications corresponding to the users’ actual usage. Therefore, the system according to the embodiment can support replacement of the plurality of electronic apparatuses 1 each including the plurality of device components.

According to the system of the embodiment, by statistically aggregating the operation information collected from the plurality of electronic apparatuses, it is possible to easily select new electronic apparatuses satisfying the requirements of most users, even when replacing a large number of electronic apparatuses.

The system of JP2003-122965 obtains simple hardware information (DMI information). On the other hand, the system according to the embodiment can propose electronic apparatuses having specifications required by the users, more appropriately than the prior art, by collecting and processing data corresponding to the users’ usage by itself. For example, by obtaining the consumed power of the USB ports, and determining whether or not each USB port is in use based on the value of the consumed power, it is possible to obtain the usage of the USB ports. As a result, it is possible to propose the number of USB ports necessary for the users. In addition, by obtaining information on whether each electronic apparatus operates with the AC power supply or the battery, it is possible to obtain the duration during which the users use the electronic apparatuses with the battery power. As a result, it is possible to propose the battery capacity required by the users.

According to the system of the embodiment, by collecting and processing information on charging and discharging of the battery, the consumed power of the USB ports, connection of external devices, and the like, from the electronic apparatuses, it is possible to determine the demand for the ports (interfaces) of the electronic apparatuses, and calculate the degree of the drop risk of the electronic apparatuses. By comparing such information with the product specifications information stored in the company, it is possible to propose the specifications of the electronic apparatuses necessary for next replacement of a customer, in accordance with the users’ actual usage.

Conventionally, an administrator selects electronic apparatuses having specifications suitable for users based on hearing or inquiry to the users, and this selection process requires very large effort for the administrator. According to the system of the embodiment, it is possible to reduce the load on the selection process by the administrator by remotely collecting and utilizing the users’ usage. In addition, in a case of selecting electronic apparatuses based on the administrator’s hearing to the users, the users tend to like device components having high performance, and the cost tends to increase due to excessive performance. According to the system of the embodiment, it is possible to select electronic apparatuses having optimum specifications with a reasonable cost by remotely collecting and utilizing the users’ usage.

According to the system of the embodiment, by obtaining dynamic operation information of the electronic apparatuses in the background, and collecting the dynamic operation information by a cloud server apparatus, it is possible to propose optimal electronic apparatuses based on the users’ actual usage.

According to the system of the embodiment, by obtaining the in-use durations of the device components, it is possible to determine the necessity of the device components based on the in-use durations.

According to the system of the embodiment, the sales representative can propose electronic apparatuses having optimum specifications based on various data. In addition, the administrator can select electronic apparatuses having optimum specifications based on various data.

### Modified Embodiment

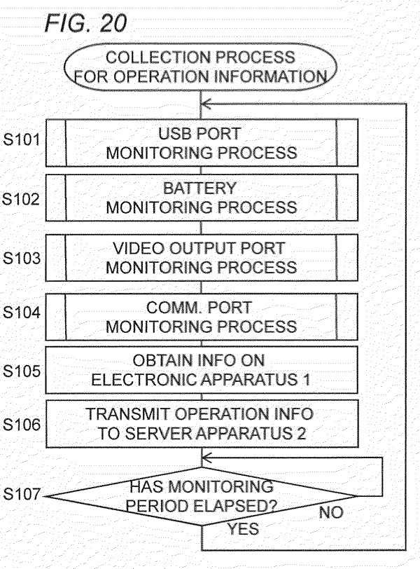

In the example of FIGS. 6 to 10, the CPU 21 of the server apparatus 2 calculates the in-use durations of the USB ports 15b, the number of simultaneously used USB ports 15b, the discharge duration of the battery 16b, the in-use durations of the video output ports 14c, the number of simultaneously used video output ports 14c, and the in-use duration of the communication ports. Alternatively, the above-described operation information may be calculated by the electronic apparatus 1. Next, a case where the CPU 11 of the electronic apparatus 1 calculates the above-described operation information will be described with reference to FIGS. 20 to 24.

FIG. 20 is a flowchart illustrating a collection process for operation information, executed by the CPU 11 of the electronic apparatus 1 according to the modified embodiment.

In step S101 of FIG. 20, the CPU 11 executes a USB port monitoring process to obtain operation information of the USB ports 15b.

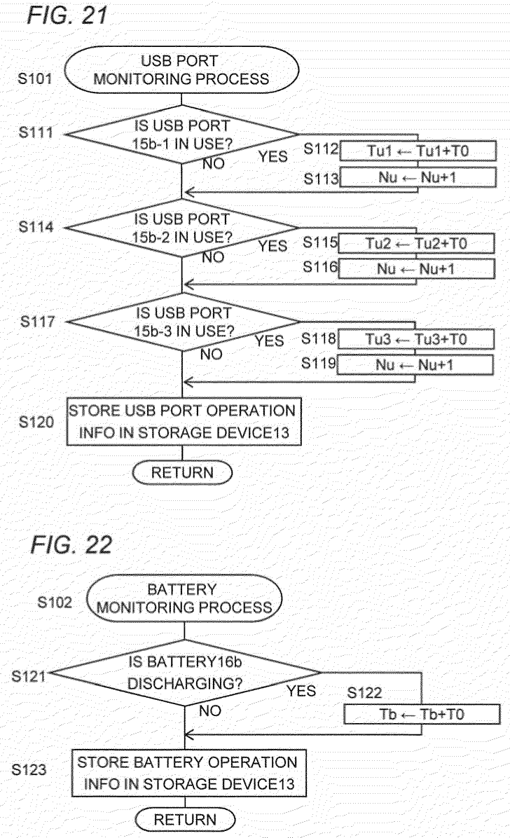

FIG. 21 is a flowchart illustrating a subroutine of step S101 (USB port monitoring process) of FIG. 20. Steps S111 to S119 are similar to steps S14 to S22 of FIG. 7. In step S120, the CPU 11 stores the USB port operation information in the storage device 13.

In step S102 of FIG. 20, the CPU 11 executes a battery monitoring process to obtain operation information of the battery 16b.

FIG. 22 is a flowchart illustrating a subroutine of step S102 (battery monitoring process) of FIG. 20. Steps S121 to S122 are similar to steps S34 to S35 of FIG. 8. In step S123, the CPU 11 stores the battery operation information in the storage device 13.

In step S103 of FIG. 20, the CPU 11 executes a video output port monitoring process to obtain operation information of the video output ports 14c.

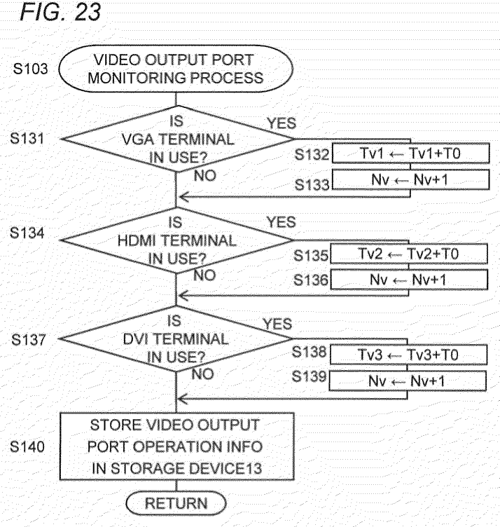

FIG. 23 is a flowchart illustrating a subroutine of step S103 (video output port monitoring process) of FIG. 20. Steps S131 to S139 are similar to steps S54 to S62 of FIG. 9. In step S140, the CPU 11 stores the video output port operation information in the storage device 13.

In step S104 of FIG. 20, the CPU 11 executes a communication port monitoring process to obtain operation information of the communication port.

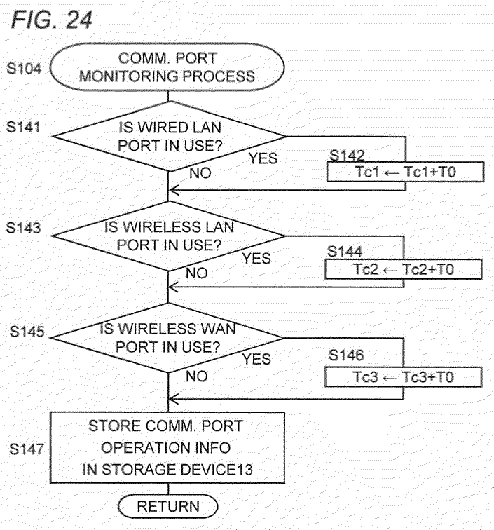

FIG. 24 is a flowchart illustrating a subroutine of step S104 (communication port monitoring process) of FIG. 20. Steps S141 to S146 are similar to steps S74 to S79 of FIG. 10. In step S147, the CPU 11 stores the communication port operation information in the storage device 13.

Steps S105 to S107 of FIG. 20 are similar to steps S5 to S7 of FIG. 6.

The CPU 21 of the server apparatus 2 statistically aggregates the operation information received from each electronic apparatus 1. Thereafter, the CPU 21 executes the recommended model determination process of FIG. 11.

According to the process of FIGS. 20 to 24, it is possible to simplify the operation of the server apparatus 2 as compared with the case of FIGS. 6 to 10.

### Advantageous Effects of Embodiments

A replacement support apparatus according an embodiment is server apparatus 2 provided for supporting replacement of a plurality of electronic apparatuses 1 each including a plurality of device components. The server apparatus 2 is provided with: a communication device 27, a storage device 23, and a CPU 21. The communication device 27 receives, from a plurality of existing electronic apparatuses 1, operation information indicating operation conditions of the device components during operation of the existing electronic apparatuses 1. The storage device 23 stores specifications information indicating specifications of new electronic apparatuses 1 as replacement candidates. The CPU 21 statistically aggregates the operation information received from the plurality of existing electronic apparatuses 1, and selects a new electronic apparatus 1 having specifications enabling operation conditions similar to operation conditions of a predetermined ratio of electronic apparatuses 1 among the existing electronic apparatuses 1, based on the statistically aggregated operation information and the specifications information. A display device 34 of a terminal apparatus 3 presents information on the selected new electronic apparatus 1.

With such a configuration, it is possible to present information on electronic apparatuses 1 as replacement candidates having specifications corresponding to the user’s actual usage.

According to the replacement support apparatus of the embodiment, the display device 34 may present the statistically aggregated operation information.

With such a configuration, it is possible to easily select new electronic apparatuses 1 satisfying the requirements of most users, even when replacing a large number of electronic apparatuses 1.

According to the replacement support apparatus of the embodiment, the device components may include one or more USB ports 15b. In this case, the operation information includes at least one of: first information indicating whether or not each of the USB ports 15b is in use, an in-use duration of each of the USB ports 15b, and a number of simultaneously used USB ports 15b.

With such a configuration, it is possible to appropriately determine specifications for the USB ports 15b according to actual usage of the USB ports 15b.

According to the replacement support apparatus of the embodiment, the communication device 27 may receive consumed power of the USB ports 15b as the first information, from each of the existing electronic apparatuses 1. In this case, the CPU 21 calculates the number of simultaneously used USB ports 15b based on whether or not the consumed power of the USB ports 15b exceeds a predetermined threshold, for each of the existing electronic apparatuses 1.

With such a configuration, it is possible to appropriately determine the number of the USB ports 15b.

According to the replacement support apparatus of the embodiment, the device components may include a battery 16b. In this case, the operation information includes a battery-powered duration of each of the existing electronic apparatuses 1.

With such a configuration, it is possible to appropriately determine the capacity of the battery 16b.

According to the replacement support apparatus of the embodiment, the CPU 21 may determine robustness requirements of each of the existing electronic apparatuses 1, based on the battery-powered duration.

With such a configuration, it is possible to appropriately determine robustness requirements of the electronic apparatuses 1.

According to the replacement support apparatus of the embodiment, the device components may include one or more video output ports 14c. In this case, the operation information includes at least one of: second information indicating whether or not each of the video output ports 14c is in use, an in-use duration of each of the video output ports 14c, and a number of simultaneously used display screens.

With such a configuration, it is possible to appropriately determine specifications for the video output ports 14c according to actual usage of the video output ports 14c.

According to the replacement support apparatus of the embodiment, the device components may include one or more communication ports. In this case, the operation information includes third information indicating whether or not each of the communication ports is in use.

With such a configuration, it is possible to appropriately determine specifications for the communication ports according to actual usage of the communication ports.

A system according to another embodiment includes: a plurality of electronic apparatuses 1 each including a plurality of device components; and the above-described server apparatus 2.

With such a configuration, it is possible to present information on electronic apparatuses 1 as replacement candidates having specifications corresponding to the user’s actual usage.

A replacement support method according to yet another embodiment, supports replacement of a plurality of electronic apparatuses 1 each including a plurality of device components. The method includes receiving, from a plurality of existing electronic apparatuses 1, operation information indicating operation conditions of the device components during operation of the existing electronic apparatuses 1. The method further includes reading, from a storage device 23, specifications information indicating specifications of new electronic apparatuses 1 as replacement candidates. The method further includes statistically aggregating operation information received from the plurality of existing electronic apparatuses 1, and selecting a new electronic apparatus 1 having specifications enabling operation conditions similar to operation conditions of a predetermined ratio of electronic apparatuses 1 among the existing electronic apparatuses 1, based on the statistically aggregated operation information and the specifications information. The method further includes presenting information on the selected new electronic apparatus 1 from an output device.

With such a configuration, it is possible to present information on electronic apparatuses 1 as replacement candidates having specifications corresponding to the user’s actual usage.

### Other Embodiments

As described above, the embodiments have been described as examples of the technology disclosed in the present application. However, the technology in the present disclosure is not limited thereto, and is applicable to embodiments with some changes, replacements, additions, omissions, and the like. In addition, new embodiments can be derived by combining the components described in the aforementioned embodiments.

Thus, other embodiments will be exemplified below.

The USB port operation information and the USB port requirements information may be generated and processed for each type of USB port (that is, type A or type C).

The electronic apparatus 1 may be provided with one or two USB ports, or four or more USB ports. In addition, the electronic apparatus 1 may be provided with one or two video output ports, or four or more video output ports.

The server apparatus 2 may be further provided with an apparatus information database storing specifications information on the existing electronic apparatuses 1. The apparatus information database includes, as entries thereof, for example, model names or product numbers of the electronic apparatuses, information on mounted ports, a capacity of a battery, and the like. In this case, when presenting information on new electronic apparatuses as replacement candidates, the CPU 21 of the server apparatus 2 may also present information on the existing electronic apparatuses 1 read from the apparatus information database.

The server apparatus 2 may be a combination of a plurality of server apparatuses, such as a data lake apparatus and a data warehouse apparatus. In this case, the data lake apparatus may temporarily store the operation information and the like collected from the electronic apparatuses 1 as they are, and the data warehouse apparatus may statistically aggregate the operation information read from the data lake apparatus.

The operation information database, the requirements information database, and the specifications information database are not limited to being stored in one storage device 23 of the server apparatus 2, and may be stored in a plurality of storage devices located at one or more places.

The electronic apparatuses as replacement candidates selected by the server apparatus may be outputted to the display device 34 of the server apparatus 2, instead of being outputted to the display device 24 of the terminal apparatus 3. In addition, the electronic apparatuses as replacement candidates selected by the server apparatus may be presented via other output devices, such as a printer connected to the server apparatus 2 or the terminal apparatus 3.

The electronic apparatuses as replacement candidates may be selected by the terminal apparatus 3, instead of the server apparatus 2. In this case, the terminal apparatus 3 obtains operation information of the device component of the other electronic apparatuses 1 from the server apparatus 2, selects electronic apparatuses as replacement candidates based on the operation information, and outputs the selected electronic apparatuses to the display device 34.

When all the electronic apparatuses 1 included in a certain group G1 are electronic apparatuses of the same model purchased at the same time, the CPU 11 of the electronic apparatus 1 and the CPU 21 of the server apparatus 2 may process data based on the model name or the product number of the electronic apparatuses 1.

The present disclosure can be used to support replacement of electronic apparatuses, such as personal computers.

What is claimed is:

1. A replacement support apparatus for supporting replacement of a plurality of electronic apparatuses each including a plurality of device components, the replacement support apparatus comprising:
a communication circuit that receives, from a plurality of existing electronic apparatuses, operation information indicating operation conditions of the device components during operation of the existing electronic apparatuses;
a storage that stores specifications information indicating specifications of new electronic apparatuses as replacement candidates;
a processing circuit that statistically aggregates the operation information received from the plurality of existing electronic apparatuses, and selects a new electronic apparatus having specifications enabling operation conditions similar to operation conditions of a predetermined ratio of electronic apparatuses among the existing electronic apparatuses, based on the statistically aggregated operation information and the specifications information; and
an output device that presents information on the selected new electronic apparatus.

2. The replacement support apparatus as claimed in claim 1,
wherein the output device presents the statistically aggregated operation information.

3. The replacement support apparatus as claimed in claim 1,
wherein the device components include one or more USB ports, and
wherein the operation information includes at least one of: first information indicating whether or not each of the USB ports is in use, an in-use duration of each of the USB ports, and a number of simultaneously used USB ports.

4. The replacement support apparatus as claimed in claim 3,
wherein the communication circuit receives consumed power of the USB ports as the first information, from each of the existing electronic apparatuses, and
wherein the processing circuit calculates the number of simultaneously used USB ports based on whether or not the consumed power of the USB ports exceeds a predetermined threshold, for each of the existing electronic apparatuses.

5. The replacement support apparatus according to claim 1,
wherein the device components include a battery, and
wherein the operation information includes a battery-powered duration of each of the existing electronic apparatuses.

6. The replacement support apparatus as claimed in claim 5,
wherein the processing circuit determines robustness requirements of each of the existing electronic apparatuses, based on the battery-powered duration.

7. The replacement support apparatus as claimed in claim 1,
wherein the device components include one or more video output ports, and
wherein the operation information includes at least one of: second information indicating whether or not each of the video output ports is in use, an in-use duration of each of the video output ports, and a number of simultaneously used display screens.

8. The replacement support apparatus as claimed in claim 1,
wherein the device components include one or more communication ports, and
wherein the operation information includes third information indicating whether or not each of the communication ports is in use.

9. A system comprising:
a plurality of electronic apparatuses each including a plurality of device components; and
a replacement support apparatus that supports replacement of the plurality of electronic apparatuses,
wherein the replacement support apparatus comprises:
a communication circuit that receives, from a plurality of existing electronic apparatuses, operation information indicating operation conditions of the device components during operation of the existing electronic apparatuses;
a storage that stores specifications information indicating specifications of new electronic apparatuses as replacement candidates;
a processing circuit that statistically aggregates the operation information received from the plurality of existing electronic apparatuses, and selects a new electronic apparatus having specifications enabling operation conditions similar to operation conditions of a predetermined ratio of electronic apparatuses among the existing electronic apparatuses, based on the statistically aggregated operation information and the specifications information; and
an output device that presents information on the selected new electronic apparatus.

10. A replacement support method for supporting replacement of a plurality of electronic apparatuses each including a plurality of device components, the replacement support method including:
receiving, from a plurality of existing electronic apparatuses, operation information indicating operation conditions of the device components during operation of the existing electronic apparatuses;
reading, from a storage, specifications information indicating specifications of new electronic apparatuses as replacement candidates;
statistically aggregating operation information received from the plurality of existing electronic apparatuses, and selecting a new electronic apparatus having specifications enabling operation conditions similar to operation conditions of a predetermined ratio of electronic apparatuses among the existing electronic apparatuses, based on the statistically aggregated operation information and the specifications information; and
presenting information on the selected new electronic apparatus from an output device.
